(19) United States
(12) Patent Application Publication
(10) Pub. No.: US 2006/0278194 A1
(43) Pub. Date: Dec. 14, 2006

(54) Finely machined surface of the pin holes of a piston

(76) Inventors: Klaus Griesbach, Ladenburg (DE); Arno Kolb, Offenau (DE)

Correspondence Address: YOUNG & BASILE, P.C., 3001 WEST BIG BEAVER ROAD, SUITE 624, TROY, MI, 48084, US

(21) Appl. No.: 10/569,542

(22) PCT Filed: Sep. 3, 2004
(86) PCT No.: PCT/EP04/09811

§ 371 Date: Feb. 23, 2006

(30) Foreign Application Priority Data
Sep. 5, 2003 (DE) 10340990.4

(51) Int. Cl. F02F 3/24

(52) U.S. Cl. 123/269

(57) ABSTRACT

Piston pinholes in a skirt section of a combustion engine piston have a surface formed with circular crater-shaped indentation. The indentations are introduced into the piston pinhole surfaces at room temperature by a blasting medium, such as a shot-peening medium, with a definite grain.

### BACKGROUND

The invention relates to a piston for a combustion engine having a skirt section in which two holes are located to locate a piston pin.

Pistons for combustion engines, in particular single-piece or multi-piece pistons (articulated pistons), are well known. Such pistons have two piston pinholes in the skirt section which are configured to locate a pin through which the piston is connected to a connecting rod. During piston operation, relative motion occurs between the piston pin and the hole so that this material pairing must exhibit sliding properties. Depending on the material pairing being used, difficulties can arise with the sliding properties so that seizing may occur. Different possibilities have been proposed to prevent seizing. One possibility is to insert a bushing into the hole which prevents it from seizing to the pin because of its material property. Inserting a bushing, however, is expensive in production, particularly in the series production of pistons and means handling additional parts, in addition to which the bushing has to be produced separately from the piston.

Further possibilities for preventing the pin from seizing in the pin hole are to introduce a groove into the pin hole which is not circumferential and is supplied with a lubricant from a cooling channel or from the interior area of the piston. Such a groove has the disadvantage, however, that lubrication is ensured in only a very specific area of the piston pin/pin hole pair. In addition, care must be taken that the lubricant, in most cases engine oil, can reach this groove. To do this, complex steps are necessary, especially when this groove is to be supplied with lubricant from a piston cooling channel. To do this, starting from the groove, a connection must be introduced going toward the cooling channel, which makes production of the piston expensive. A further measure, similar to the radially circumferential groove, is the introduction of a helical channel into the surface of the piston pin hole, which means expensive production and did not bring satisfactory results regarding the sliding properties.

It would be desirable, therefore, to prepare a piston for a combustion engine in which the sliding property of the piston pin in the pin hole is improved and seizing is reliably prevented.

### SUMMARY

The present invention is a combustion engine piston pin hole surface configuration which improves the sliding property of the piston pin in the pin hole and reliably prevents ceasing.

In one aspect, the surface of the piston pinholes has a plurality of circular crater-shaped indentations. The indentations are introduced into the piston pin hole surfaces at room temperature. The indentations can be introduced into the piston pin hole surfaces by a blasting medium, such as a shot-peening medium, which has a definite grain.

The piston pin hole surface configuration of the present invention improves the sliding property of the piston pin in the piston pin hole and reliably prevents seizing.

### DETAILED DESCRIPTION

In accordance with the invention, the intention is for the surface of the pin hole to have a plurality of crater-shaped indentations. As such, the surface of the pin is comparable, for example, to the intrinsically familiar surface of a golf ball. This plurality of crater-shaped indentations have the advantage that oil retention volume is increased and the lubricant, in particular engine oil, collects in them and can form a lubricating film, or a supporting cushion. Seizing is effectively prevented by the formation of this lubricating film because of the relative motion of the pin in the pin hole. At the same time, the hole retains adequate load-bearing properties which are important to the piston pin. It is of particular advantage that the indentations are approximately circular so that, on the one hand, sufficient indentations are created to contain the oil, and, on the other hand, the craters or indentations prevent the oil from flowing away during a change in contact. The blasting medium has a defined grain, for example, shot which is spherical as far as possible. The surfaces of the piston pinholes are bombarded with this shot-peening medium, which is expelled at high speed, so that the grains create the crater-shaped indentations upon impact but do not themselves penetrate the material.

It is a further advantage that during the shot-peening, residual compressive stress is induced in the surface through cold working which contributes to an increase in strength.

What is claimed is:

1. A piston for a combustion engine with a skirt section in which two piston pinholes are located to receive a pin, the improvement comprising the surface of the piston pinholes having a plurality of crater-shaped indentations where the indentations are circular.

2. The piston of claim 1, wherein the indentations are introduced into the piston pin hole surfaces at room temperature.

3. The piston of claim 2, wherein the indentations can be introduced into the piston pin hole surfaces by a blasting medium which has a definite grain.

4. The piston of claim 3, wherein the blasting medium is a shot-peening medium.

5. The piston of claim 1, wherein the indentations can be introduced into the piston pin hole surfaces by a blasting medium which has a definite grain.
